(19) United States
(12) Patent Application Publication
(10) Pub. No.: US 2013/0058214 A1
(43) Pub. Date: Mar. 7, 2013

(54) Method and apparatus to avoid overloads on subscriber access lines

(71) Applicants: Andreas Foglar, Munich (DE); Klaus Starnberger, Moedling (AT); Erik Norden, San Jose, CA (US)

(72) Inventors: Andreas Foglar, Munich (DE); Klaus Starnberger, Moedling (AT); Erik Norden, San Jose, CA (US)

(21) Appl. No.: 13/385,456

(22) Filed: Feb. 21, 2012

(30) Foreign Application Priority Data
Feb. 17, 2011 (DE) 102011011400.9-31

(51) Int. Cl. H04W 28/10

(52) U.S. Cl. 370/230.1

(57) ABSTRACT

A communication system has special Agents in the subscriber terminals which detect the need of applications for data paths with QoS over the access network. The Agents have packet based control channels to a Remote Resource Manager installed outside the network typically as a web server and use the control channels for sending bandwidth allocation requests to the Remote Resource Manager which stores all bandwidth relevant information for a subscriber and delivers bandwidth and QoS class back to the Agents which adjust packet rate and packet QoS class marking accordingly. A Self-Sustaining Scheduler placed in the bottlenecks of the data path guarantees given delay times per QoS class and keeps packet drop rate below given limits if the Remote Resource Manager assigns bandwidth appropriately.

### PRIORITY

This Application claims priority benefit of German Patent Application 10 2011 011 400.9-31, which was filed on Feb. 17, 2011. The entire contents of the German Patent Application are hereby incorporated herein by reference.

### FIELD OF INVENTION

The field of invention relates generally to Quality of Service (QoS).

### BACKGROUND INFORMATION

The subscriber access line is a bottleneck for data transmission. At both sides of the line, within the public access network on one side and in the home network on the other side basically unlimited bandwidth is available. In the public network the backbone bandwidth is being increased by introduction of wavelength division multiplex (WDM) and in the public access network the introduction of gigabit Ethernet technology leads to considerable increase of bandwidth as well. In the home network next generation WLAN systems and Power-Line Communication (PLC) provide more and more bandwidth.

On the subscriber access line, also called first or last mile, a corresponding increase of bandwidth is not possible. Be it twisted pair copper, PLC (as access line) or any wireless technology the bandwidth is limited by physical limits (Shannon limit) and administrative limits (maximum transmit power, frequency bands). These limits can only be overcome by new physical technologies such as fiber optic, but this replacement by will need decades. Even some optical technologies such as Passive Optical Network (PON) have inherent bandwidth limits, especially in upstream direction.

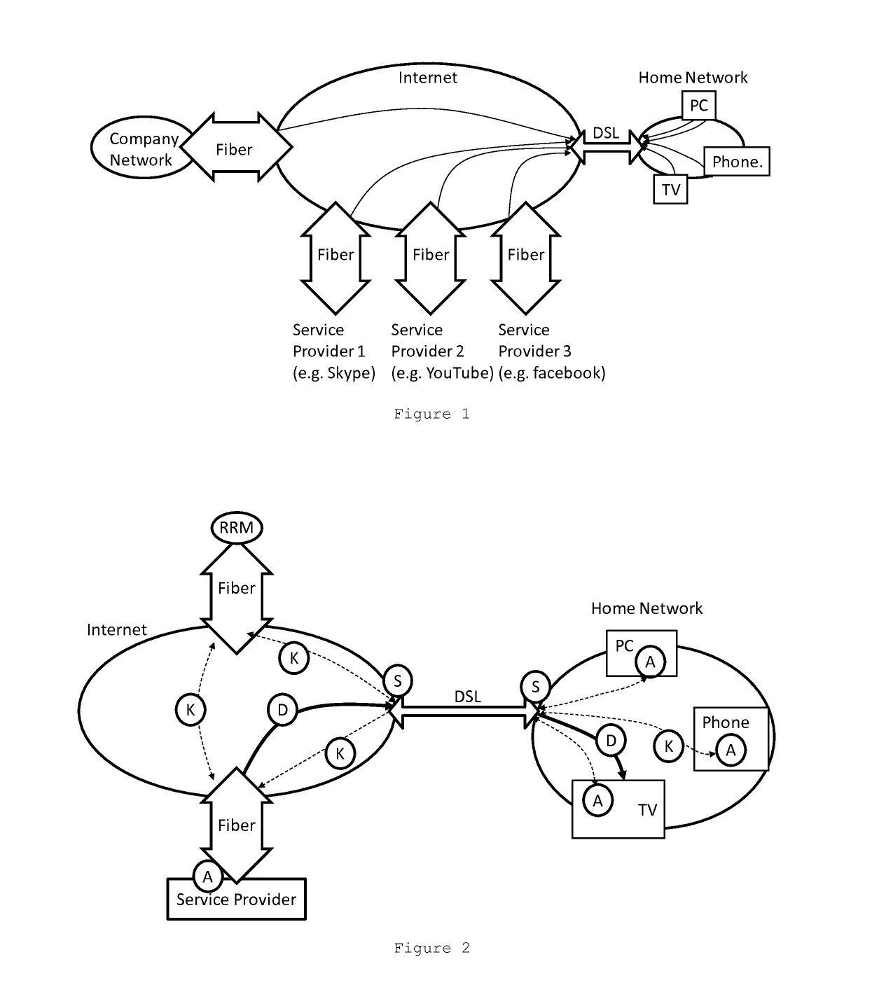

Therefore we have today the scenario depicted in FIG. 1. The subscriber has a manifold of simultaneous communication relations to service providers for data, video, Voice over IP (VoIP) and peer-to-peer applications, for example to other subscribers or VPN connections for company access. All these have to share the limited bandwidth of the subscriber access line. Today this sharing is done uncoordinated without considering the needs of the respective applications, resulting in unwanted effects such as voice interruption, flickering video and others.

Patent WO0309146A1 proposes a bandwidth reservation for the access network, especially for VoIP calls. The basic idea is again the concept that the network is the master. The difference is that request for bandwidth is not explicit, but the access network sniffs the signaling packets (SIP packets) exchanged between subscriber and VoIP provider and derives a reservation request from their content. Once the bandwidth is obtained the remaining procedure follows the POTS model. Subscriber data base and traffic management data base (FIGS. 2 and 5) are consulted and if available the bandwidth is reserved. WO0309146A1 also exhibits significant complexity for SIP message parsing at the one hand and on traffic management on the other hand. The main part of this patent deals with this complexity.

Also EP1453260 follows the POTS model. Central instance to manage resources in this case is the Edge Router.

In WO02/019055A2 an external Bandwidth Broker performs access control, but on behalf of the network. Hence this application follows the also the POTS model. Although the Bandwidth Broker seems to be similar to the Remote Resource Manager of this application there is a fundamental difference. The Remote Resource Manager acts on behalf of the subscriber via the Terminal Agents, while the Bandwidth Broker in WO02/019055A2 is the deciding instance of the network.

Several patents could be found describing methods and apparatus for bandwidth information management:

DE602004009677T2, U.S. Pat. No. 6,970,428B1, U.S. Pat. No. 5,905,715, US20090109976A1, US2011010444A1, U.S. Pat. No. 5,774,689.

These patents have a fundamental difference to the present application as they manage the total bandwidth on a link. In networking terms these are methods of the management plane, while this application is a method of the control plane. In the management plane the total bandwidth is statically configured, while in the control plane the dynamic sharing of the total bandwidth by the various flows on that link.

Therefore DE602004009677T2 und US2011010444A1 use layer 1 communication channels (Embedded Operations Channel EOC of DSL) or layer 2 communication channels (ATM Permanent Virtual Channel PVC) in U.S. Pat. No. 6,970,428B1 und US20090109976A1. This application operates at the layer 3, the Internet Protocol layer. It may use the methods of the mentioned patents to obtain the total bandwidth of a subscriber access line. Alternatively the so-called DSL speed test may be used to determine the total bandwidth of an access line.

### SUMMARY OF THE INVENTION

The invention solves the problem exploiting the fact that the only remaining bottleneck in an end-to-end communication will be the subscriber access line. The new idea is that the subscriber is given control and responsibility over his access line to manage bandwidth sharing of application flows by himself. He does it according to the invention with the help of Terminal Agents in the terminals, a Remote Resource Manager and a Self-Sustaining Scheduler located at the bottlenecks of the data path, i.e. the endpoints of the subscriber access line.

The Self-Sustaining Scheduler has a well-known behavior in processing flows of different QoS classes, and this behavior is independent on load conditions. Hence it does not need any reconfiguration by the access network operator.

The Remote Resource Manager can be realized as Internet service acting as QoS service provider. It knows all flows of a customer and assures that no overload situation occurs in the Self-Sustaining Schedulers at both sides of the access line thanks to intelligent bandwidth management algorithms. A Remote Resource Manager can serve several customers/subscribers. It communicates with each customer via communication channels to Terminal Agents located in the terminals of a subscriber.

The Terminal Agents in the subscriber terminals can be realized as dedicated circuits, as software plug-in, as applet (App) or combinations of them. Pure software implementations have the advantage of being downloadable in existing equipment, while hardware implementations have higher performance. A Terminal Agent sends requests to the Remote Resource Manager and receives instructions how to enforce QoS methods locally within the terminal. QoS methods are basically flow send rates, flow packet marking and optionally remote control of flow receive rates.

Main advantage of the described solution is maintenance of network neutrality. Unlike existing “Triple Play” solutions QoS support is not limited to services offered by the access network provider, but can be provided for any application flow from everywhere in the world. The Remote Resource Manager is neutral to applications, as it does not need any information about the content of a service, only about its QoS parameters.

The Remote Resource Manager can be optimized for the purpose of bandwidth management and can offer QoS with high quality. Subscriber and service provider are relieved from this complex problem. Algorithms can be shared by all subscribers supported by a Remote Resource Manager. The access network operator is alleviated from the burden to guarantee the selected service class to the customer at any time. The only contribution of the access network operator is to install the Self-Sustaining Scheduler at the network side of the subscriber access line. The responsibility is finally at the subscriber assisted by the Remote Resource Manager via the Terminal Agents.

A further advantage of the invention is increased efficiency for data transmission. Today in case of overload at bottlenecks in the network packets are discarded and must be retransmitted end-to-end. The percentage of retransmitted packet is significant, as the prevailing Transmission Control Protocol (TCP) by intention uses packet losses as a measure to adjust the data rate. With an estimated power consumption of all Internet nodes of about 150 billion kWh per year reducing the amount of retransmission has a high potential of energy saving.

The solution proposed in this patent application differentiates in a key point from all known systems. In all network concepts, starting from the plain old telephone system (POTS) the network is the master. A subscriber requests a connection, for example by dialing, and either gets it assigned (he hears the ringing tone) or denied (he hears the busy tone). This “POTS Model” is used for mobile telephony as well and ITU-T planned to extend it for broadband networks under the denomination B-ISDN, but this was abandoned. Today a global solution for QoS over IP networks is in standardization by 3GPP (3^{rd} Generation Partnership Project) under the denomination IMS (IP Multimedia Subsystem). Also IMS follows the POTS Model. This undertaking is even more complex than B-ISDN, so that a final solution is still far away.

In the present application the subscriber is the master. He has a set of resources assigned by the network and it is his decision which flow should be prioritized.

In the above mentioned Triple Play solution Internet, VoIP and TV/Video on Demand (VoD) are offered as a package with high quality. However, this solution only works if all three services are offered by the access network operator. Hence this solution disables network neutrality and unbundling. If a subscriber uses VoIP of another operator, Skype service or watches YouTube video the QoS is reduced to Best Effort.

B-ISDN solution could not cope with the fact that the content of one single web page can be composed by packet bursts from a manifold of servers. It is not practical to signal a dedicated connection for each burst. This application solves this problem by managing the bandwidth of all bursts at the destination point according to claim 12.

For VoIP there exists a setup procedure like in the POTS service using the Session Initiation Protocol (SIP), but it does not include QoS. The VoIP server basically communicates IP addresses only. There is no bandwidth reservation.

### DETAILED DESCRIPTION

Embodiments of methods and apparatus for supporting QoS over subscriber access lines are described herein along with these Figures:

FIG. 1 is a typical networking scenario;

FIG. 2 concept of the QOS solution;

FIG. 3 an example for intelligent bandwidth management;

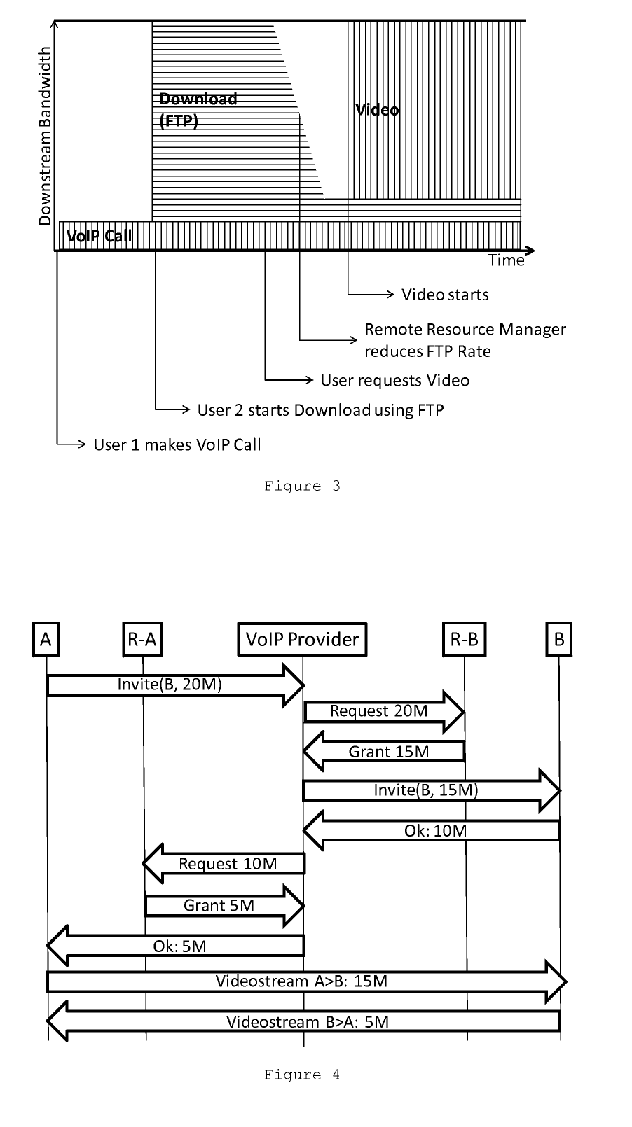

FIG. 4 an example for video conference setup;

FIG. 5 positioning of the Self-contained Scheduler;

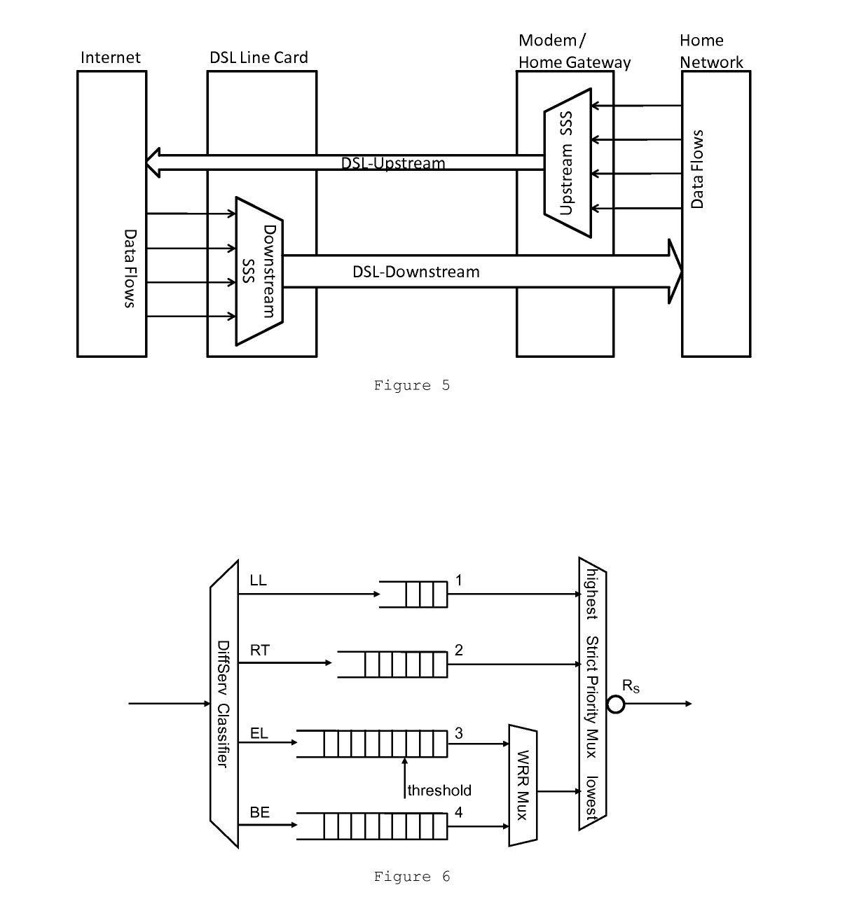

FIG. 6 the preferred implementation of the Self-contained Scheduler;

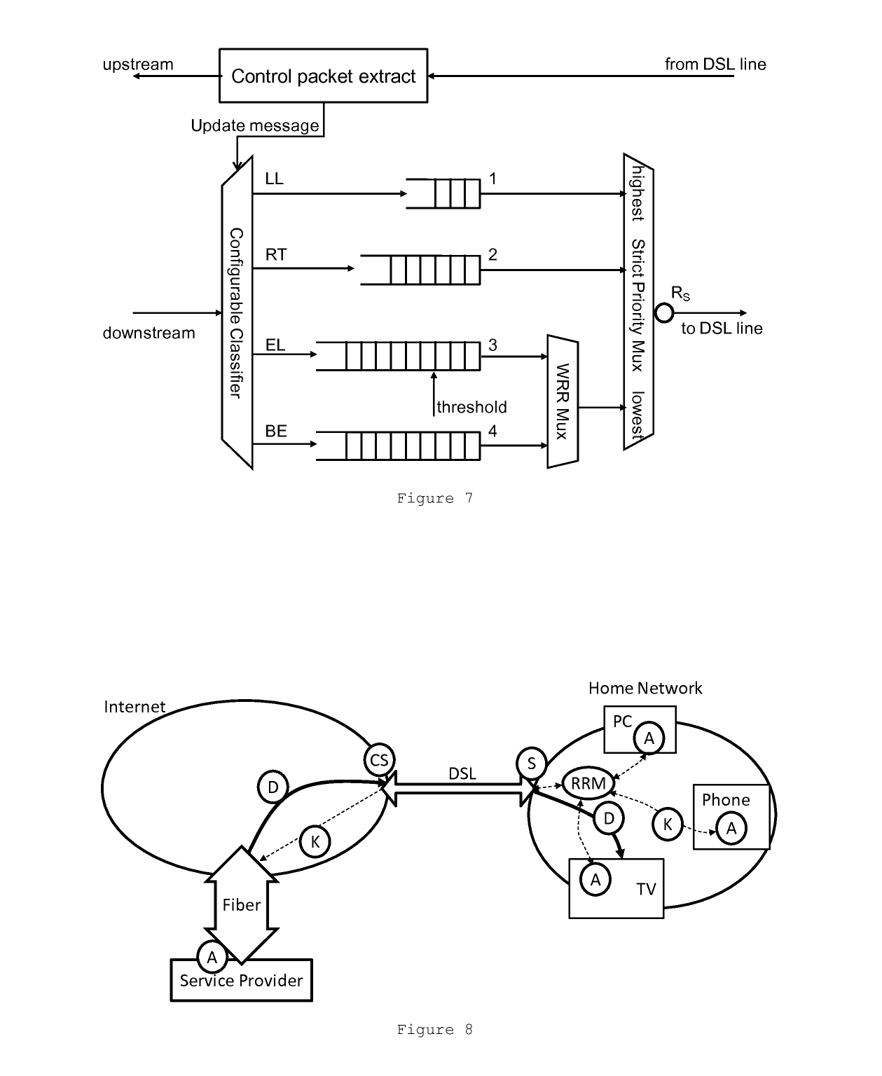

FIG. 7 Self-Sustaining Scheduler with configurable Classifier; and

FIG. 8 Alternative Concept of QoS Solution.

The whole concept is shown in FIG. 2. Three components must cooperate to guarantee QoS over the subscriber access line:
Remote Resource Manager (RRM)
Self-Sustaining Scheduler (S)
Agents (A) in the terminals of the subscriber and optionally also within the terminals of the service provider.

The end customer is subscribed at the Remote Resource Manager. All his terminals have Control Channels (K) from their Agents to the Remote Resource Manager. All bandwidth relevant information is communicated by the Terminal Agents to the Remote Resource Manager, so that is has at any moment the overview about the load situation of his customer.

The Self-Sustaining Scheduler is especially constructed to be configured statically. It operates based on the QoS marking in the data packets. QoS marking is done at the sources according to the directives of the Remote Resource Manager. Special fields in the IP packet header are used for marking.

The interworking of the components is described along with FIG. 2. A subscriber requests a video to be delivered from the service provider. Before delivering the video the service provider gets the available bandwidth on the subscriber's access line from the Remote Resource Manager. Control channels (K) are provided for this purpose between Remote Resource Manager and Service Provider and Remote Resource Manager and all subscriber terminals (PC, VoIP Phone, TV). The delivered video packet stream in FIG. 2 is denoted with (D). Optionally the subscriber could inform the service provider directly about his available bandwidth, shown in FIG. 2 with a direct control channel (K). This direct information from customer to service provider could be done via an explicit control channel such as Real Time Control Protocol (RTCP) in parallel to a Real Time Protocol (RTP) in case of UDP, or in case of TCP implicitly by delaying emission of acknowledge packets.

In FIG. 2 the symbol (S) denotes the Self-Sustaining Schedulers on both sides of the subscriber access line (DSL). Hence one is located in the public network (downstream direction), the other one in the home network of the subscriber (upstream direction). In this application the downstream direction is in focus; it is owned by the network operator but controlled by the subscriber. This conflict is solved by the use of a Self-Sustaining Scheduler which works without any re-adjustment and which is so robust, that no misuse may affect its stability. In fact the principle of operation of the Self-Sustaining Scheduler is that the maximum delay for each QoS class is guaranteed under all load conditions, but the packet drop probability is guaranteed only if the specified load is not exceeded.

Thanks to the precise bandwidth assignment for all application flows sharing the Self-Sustaining Scheduler by the Remote Resource Manager, the specified maximum load is not exceeded so that the applications can rely on the specified packet drop probabilities for each QoS class.

In case the available bandwidth is not sufficient to receive a video stream the Remote Resource Manager may decide to reduce other applications' bandwidth before enabling the video stream. This mechanism is described below with an example. The decision depends on preferences the customer has provided to the Remote Resource Manager at subscription time. Alternatively the video flow could also be rejected or delivered—with poor quality—using the lowest QoS class “Best Effort”.

The Remote Resource Manager has these tasks:
Termination of control channels to terminals
Termination of control channels to the service providers
Intelligent, dynamic flow bandwidth assignment
Web site for subscription, configuration of customer preferences and download of plug-ins or applets (Apps) for the customer terminals (e.g. VoIP Client, Browser, Video Player, File Transfer Protocol (FTP), Speed Test etc.).

For the control channels to the terminals the Session Initiation Protocol (SIP) could be used. It is widely in use for VoIP, multimedia signaling and for mobile applications. With the optional embedded Session Description Protocol (SDP) it allows specification of QoS parameters. SIP would be ideal for a first implementation of the concept, as it is already available. Its drawback is the high parsing effort due to its plain text formats. For a volume introduction of the concept a more compact, binary coded control packet format would be more efficient. A preferred implementation is described below.

An example for intelligent bandwidth adjustment is described along with FIG. 3. It shows a time window with 3 different applications. At the beginning only a packet stream of a VoIP call of User 1 is active, occupying a small part of the available downstream bandwidth. Sometime later a download of User 2 starts and uses the whole remaining bandwidth. The strategy is obviously to terminate the download as fast as possible. Again sometime later User 3 requests a video. According to the preferences of this subscriber the Remote Resource Control first reduces the download speed to provide a sufficient bandwidth for reception of the video.

The advantage of the present application becomes obvious in this example. Without intelligent bandwidth management the video source would just start sending packets at maximum speed. Due to packet collisions at the downstream scheduler both video stream and FTP packets would be dropped. Loss of FTP packets would lead to bandwidth reduction via TCP and then stepwise increase of FTP bandwidth until packet losses occur again. The two applications would permanently compete with each other with impairments for both applications.

An example for initiation of a video call is shown in FIG. 4. Normally in such a process only 3 parties would be involved, the subscribers (A) and (B) and the Service Provider. According to this application the 2 Remote Resource Managers of (A) subscriber (R-A) and the one of the (B) subscriber (R-B) are involved in the process. Setup is initiated by subscriber (A) who has an available upstream bandwidth of 20 Mb/s. So he sends the message to (B): “Invite(B, 20M)”. According to state of the art the message would be sent to the Service Provider which would forward the message to (B) if (B) is online. Here the message is forwarded to the Remote Resource Manager (R-B) of (B). (R-B) knows exactly the available bandwidth on subscriber access line of (B). In this example the available bandwidth is 15 Mb/s and (R-B) grants this bandwidth back to the Service Provider with the message “Grant 15M”. Accordingly the reduced invitation “Invite 15M” is sent to (B). Subscriber (B) accepts the call and acknowledges it with his available upstream bandwidth of 10 Mb/s for the backward direction with the message “Ok: 10M”. Now the same procedure continues for the backward direction, where subscriber (A) has only 5 Mb/s available in his downstream direction. Finally the two video streams are exchanged with 15 Mb/s from (A) to (B) and with 5 Mb/s from (B) to (A). Video conferencing equipment according to the state of the art would not support the additional functionality needed for this application:
Bandwidth negotiation
Communication with Remote Resource Manager
Packet rate adjustment and packet QoS marking.

These functions are done by Terminal Agents.

In case of a VoIP phone with fixed bandwidth negotiation and packet rate adjustment are not needed. In this case the Remote Resource Manager would use a fixed bandwidth for VoIP channels. It is sufficient to know begin and end of the call. The SIP packets could be sent to the Remote Resource Manager which would act as VoIP server. Today's VoIP phones send packets with special QoS coding according to DiffServ, so that packet marking is not needed either.

In this example both subscribers have different Remote Resource Managers. They could also be subscribed at same Remote Resource Manager.

As can be seen from FIG. 4 the additional messages are exchanged between Service Provider and QoS providers (Remote Resource Manager). Obviously service provider and QoS provider must have a business relationship.

In case the procedure of bandwidth assignment is too slow it could also done in parallel. Terminals start to exchange data immediately, but with packets marked with the lowest QoS class Best Effort. When the parallel process of bandwidth negotiation is concluded the assigned rate is adjusted by the terminals (via the Agents) and the packets are sent with the given QoS class. This procedure has the advantage that the subscriber immediately gets video and voice connectivity while the quality follows a bit later.

For bandwidth management the Remote Resource Manager needs the actual total bandwidth of the subscriber access line in up- and downstream direction. These values could be obtained via a so-called speed test initiated by the Remote Resource Manager and executed by an agent within the subscriber premises network.

For the application Internet browsing where data bursts are exchanged another mechanism is used for bandwidth control. Signaling available bandwidth to the sources would not be practical, as typical web sites are composed of data bursts coming from many different servers. TCP over IP is the basic protocol used for all web data transfer except audio/video data. TCP includes a flow control algorithm to limit the transmit rate to the processing rate of the receiver. By delaying TCP acknowledge packets (ACK) and/or by setting the Receive Window field in ACK packets the total receive bandwidth of all sources can be controlled. The TCP flow control loop has a certain latency which may lead to data burst accumulation in the Self-Sustaining Scheduler at the network side. Its buffer is dimensioned accordingly to buffer these bursts.

### The Self-Sustaining Scheduler

FIG. 5 shows the location of the Self-Sustaining Scheduler (SSS) at both sides of a Digital Subscriber Line (DSL) line. In this example a DSL line based on twisted pair copper wire is chosen as bottleneck, although the method of this application is applicable to any access type constituting a bandwidth bottleneck. In the example of FIG. 5 each Self-Sustaining Scheduler receives 4 data flows and shapes them to the available bandwidth, visualized by arrows with different width for up- and downstream direction for the usually asymmetric DSL access.

The Self-Sustaining Scheduler works autarkic with one fixed configuration which adapts automatically to changing load conditions. This is achieved by the preferred implementation according to FIG. 6 described in the following.

In FIG. 6 the packet stream enters the DiffServ classifier at the left, where it is separated in four Qos flows based on the DiffServ Code Point (DSCP) field of the IP packet header. This field is present in both IPv4 and IPv6 options. It is 6-bit wide for 64 code points. A mapping table (Table 1 below) gives the mapping of DSCP values to queues for the preferred implementation and also the abbreviations LL, RT, EL and BE of the 4 QoS flows. Each of the 4 QoS flows is stored in a separate queue. Queue 1 has the highest time priority and queue 4 the lowest. The QoS classes in the preferred implementation are differentiated by time behavior; more precisely each queue has a maximum latency time which is guaranteed by a time stamp mechanism. Packets which are waiting more than the specified latency time in a queue are discarded.

The 4 queues in FIG. 6 are served by 2 cascaded multiplexers, queue 3 and 4 first with Weighted Round Robin (WRR) serving strategy and then queue 1 and 2 together with the output of multiplexer 1 in a second multiplexer with strict priority serving strategy. In the preferred implementation the WRR weights are selected 31:1, so that queue 3 is 31-times more frequent than queue 4. Queue 3 has a threshold which is chosen at ca. 10% of the total queue size.

The Remote Resource Manager cooperates with the Self-Sustaining Scheduler of FIG. 6 in such as way that flows with peak rate reservation are assigned to the queues 1 and 2. This bandwidth assignment is used for applications which generate (almost) constant packet streams (streaming applications). Using statistical methods the Remote Resource Manager limits the total reserved rate for queue 1 and 2 to such value that the packet drop probability due to queue overflow is kept below a specified value; in the preferred implementation 10⁻¹¹. This drop rate is so low that one lost packet event occurs very rarely, typically within several hours.

The strict priority multiplexer serves queue 1 with highest priority. Only if queue 1 is empty queue 2 is served and only if queue 1 and 2 are empty the WRR multiplexer is served. This behavior can lead to starvation of the queues connected to lower priority inputs. Therefore the Remote Resource Manager uses peak rate reservation for the flows in queue 1 and 2, assuring that there is bandwidth left for flows forwarded by the other queues.

Queue 3 supports both streaming and burst applications. The latter are applications with so-called on-off traffic, as its generated for example by “classical” Internet browsing (without embedded video or audio) or by client-server computing. Peak reservation for on-off flows would be a waste of bandwidth resource, as their applications are not always sending data. For example in a web browser session a user could read a page for minutes and then click to the next page. During the silence period other applications could use the bandwidth. This is called statistical multiplexing. Reservation of minimum bandwidth assures that even if by coincidence of bursts from all applications there is still enough bandwidth for each application to continue to work. Some applications need a minimum bandwidth to work. For example in client-server computing acknowledge signals should not exceed certain time values. In an Internet browsing session a minimum rate is given by the patience of the user.

Hence the maximum size of queue 3 is combines peak rate reserved streaming flows and minimum rate reserved on-off flows. Using statistical methods the Remote Resource Manager keeps bandwidth reservation below a certain limit, so that packet drop probability due to overflow is maintained below a given limit, in the preferred implementation 10⁻⁷. For on-off flows this drop rate is guaranteed only for rates up to the guaranteed minimum rate; packets exceeding the minimum rate must be marked by the source with low importance. These are allowed to fill queue 3 up to the threshold, but are discarded when the fill level is beyond the threshold. In other words less important packets are forwarded only if queue 3 is almost empty.

The correct marking of packet importance must be assured by the terminal either content agnostic or content aware. In the content aware option the application provides important and less important packets. For example a video source could mark packets of the basic video stream as important, while packets of the enhancement stream could be marked as less important. The rate of the basic video stream would have to be reserved. In the content unaware option the Terminal Agent does the marking by rate measurement without looking at the content.

Loss of basic stream packet could lead to loss of picture synchronization and hence cause a severe distortion with picture breakdown, while the loss of an enhancement packet would only temporarily reduce picture sharpness in a part of the picture. Similarly a data stream could be split at the source in important and less important packets. For example a web page could have important data such as the list of articles and prices, while background image could be marked as less important.

The threshold of queue 3 hence is essential for statistical multiplexing. Locating at about 10% of maximum size (preferred implementation) has two effects, obtained from statistical calculus:
1. The important packets have almost the whole queue available for very low packet drop probability of 10⁻⁷.
2. Packets of low importance still have between 99% and 99.9% probability of acceptance.

The lowest priority QoS class is called Best Effort. It has no guarantees in delay and drop probability, but a minimum serving rate is guaranteed by the WRR multiplexer. In the preferred implementation about 3% of queue 3 serving rate is used for queue 4. This seems to be a low value, but as all applications are assigned the QoS class and the bandwidth they need only few packets will use queue 4.

In the current Internet all packets are treated with the same priority. If network operators would provide high and low priority support everyone would send data with high priority only. Hence an enforcing function such as QoS flow rate policing per subscriber would be needed. This is part of the classical POTS-like approach. The concept of this invention exploits the fact that each subscriber is responsible for his own traffic. He is motivated to mark packets correctly with the priority assigned by the Remote Resource Manager to assure optimum QoS for all flows.

All queue sizes are guaranteed by the Self-Sustaining Scheduler in absolute time values, with the preferred time values given in Table 1. It is realized by receive time stamps for each packet which are checked when the packet is read from the queue for transmission. If the delay exceeds the given value for the queue the packet is discarded. This has the advantage for the application that it must not wait more than a given time for a packet. In a streaming application it might be abandoned while in data applications retransmission will be requested.

For the threshold of queue 3 also a time value is specified, but it is checked by a different mechanism. When a packet of low importance arrives its arrival time is compared with the arrival time of the longest waiting packet in queue 3 and if this value exceeds the given maximum the packet is dropped.

Absolute time values have the advantage that no re-adjustment is necessary. Time limits and the special arrangement of strict priority and WRR schedulers constitute the Self-Sustaining Scheduler.

The preferred implementation of the QoS classes also includes maximum packet size values (Table 1). Optionally the Self-Sustaining Scheduler could also supervise these values and discard exceeding packets.

### The QoS Classes

Specification of QoS classes must fit to the Self-Sustaining Scheduler and also to the bandwidth reservation algorithms of the Remote Resource Manager.

In the preferred implementation 4 QoS classes are specified with one of them (EL) having 2 importance levels as shown in Table 1.

TABLE 11
QoS Classes

| | DiffServ | | Maximum | Maximum |
|---|---|---|---|---|
| | Coding | Maximum | Packet | allowed |
| QoS Class | (DSCP) | Latency | Drop Rate | Packet Size |
| Low Latency (LL) | 63 . . . 56 | 1 ms | 10⁻¹¹ | 200 Byte |
| Real Time (RT) | 55 . . . 32 | 30 ms | 10⁻¹¹ | 1500 Byte |
| Elastic (EL) | 31 . . . 24 | 900 ms | 10⁻⁷ | 9000 Byte |
| | 23 . . . 8 | 100 ms | <1 | 9000 Byte |
| Best Effort (BE) | 7 . . . 0 | n.a. | <1 | 9000 Byte |

Table 1 contains the maximum latency and drop probability values which are guaranteed when the packet size does not exceed the maximum allowed value. In the DiffServ column the preferred mapping of DSCP values to the QoS classes is specified. The DiffServ standard RFC4594 specifies 64 DSCP values with 63 having highest (relative) priority and 0 the lowest. In Table 1 DSCP value ranges are assigned to the 4 classes and importance levels.

Split of EL class into 2 importance levels allows statistical multiplexing with minimum guaranteed bandwidth reservation as described with the Self-Sustaining Scheduler above.

The preferred QoS class selection of Table 1 has these advantages:
1. The distinction of QoS classes by the latency is well recognized by the user.
2. Maximum latency allows calculation of round trip delay and prediction of packet arrival times
3. The highest class LL has very low latency and is therefore suitable for very stringent requirements
4. The RT class is ideal for VoIP and video conferences
5. EL class is suitable for streaming such as in IPTV or Video on Demand (VoD)
6. Two classes for real time applications (LL, RT) and two classes with statistical multiplex gain (EL, BE)
7. Very low packet drop rates.

The QoS classes are a key part of the concept. The Remote Resource Manager assigns peak or guaranteed minimum bandwidth to the applications and the Agents in the terminals must control the send rates of each flow and mark the packets with the right DSCP coding. In case of EL class the marking can also be dynamic (tagging) depending on send rate. If the bandwidth conditions are fulfilled the Self-Sustaining Scheduler guarantees the packet drop rates.

### Compact Packet Format for the Control Channels

The QoS of a packet stream can be completely described using three orthogonal parameters Guaranteed Rate, QoS Class and Retention Priority.

The Guaranteed Rate is the bandwidth to be reserved by the Remote Resource Manager and it is used by the Terminal Agents to shape the sent packet streams. A Guaranteed Rate for the low importance EL stream must not be specified or maintained.

The QoS class is assigned to the application flows by the Remote Resource Manager knowing the customer preferences. Optionally the Terminal Agents can hide the application and provide the QoS parameters to the Remote Resource Manager which then has to check the available bandwidth and optionally modify existing flow rates according to the customer preferences. The Self-Sustaining Scheduler uses QoS class and importance level for scheduling.

The Retention Priority of a flow is needed by the Remote Resource Manager only to solve bandwidth conflicts as described above with the example of FIG. 3. It is related to the customer preferences and tells which flow can reduce or push-out another flow with lower Retention Priority. Typically emergency calls will be assigned the highest Retention Priority, while e-mail service could be assigned a low Retention Priority.

Table 2 shows a preferred coding of the 3 QoS parameters.

TABLE 22
Coding of QoS Parameters

| | |
|---|---|
| Guaranteed Rate | 16 bit |
| QoS Class | 2 bit |
| Retention Priority | 4 bit |

For the Guaranteed Rate multiples of 100 kbit/s are proposed. A 16 bit value allows specification of guaranteed rate values up to 65 Mbit/s.

For the 4 QoS classes 2 bit are sufficient, as the 2 importance levels of the EL class must not be specified. The Guaranteed Rate is always related to the high importance stream.

For the Retention Priority a 4 bit value allows 16 different values.

### Alternative Option for Remote Resource Manager

The Remote Resource Manager is in some embodiments indicated as being external to the network where the data is forwarded. However, this does not exclude the option that the Remote Resource Manager is in the subscriber network, the home network. In this case the Remote Resource Manager might favorably be included in the modem or home gateway, which could also contain some Terminal Agents acting as proxy for terminals which do not include Terminal Agents.

### Alternative Option for Self-Sustaining Scheduler

This option is based on the idea to make the classifier in the Self-Sustaining Scheduler more intelligent, more complex, but still self-sustaining. The flow classifier in FIG. 6 is based on DiffServ Code Points DSCP. This fact could be misused for example by service providers sending advertisement via popup windows, videos, flash or other spam. They could mark their packets with high priority QoS class without being requested—and considered—by the Remote Resource Manager. These unwanted packet flows could disturb all other flows.

As a remedy a configurable classifier in the Self-Sustaining Scheduler could explicitly learn from the subscriber which flows which flows should be prioritized. All other flows would be assigned to the default QoS class (Best Effort). If a subscriber wants to receive an incoming flow with higher priority the respective Terminal Agent identifies the packets by a suitable combination of header fields and sends this identification back in upstream direction to the DSLAM together with the desired QoS class.

The other part of the process, bandwidth assignment by the Remote Resource Manager and transfer of this information to the involved terminals is unchanged. FIG. 8 shows an example where the Remote Resource Manager is inside the home network. Again (K) denotes control channels, (A) the Terminal Agents and (D) the video stream from service provider to subscriber.

At the network side of the DSL line the Self-Sustaining Scheduler is enhanced by a configurable classifier as shown in FIG. 7. In this figure a control packet extraction block has been added to the Self-Sustaining Scheduler from FIG. 6 and the DiffServ classifier is replaced by the configurable classifier.

The configurable classifier can learn a given number of flows, for example 100 flows per subscriber. For this purpose it contains a table of 100 entries consisting of flow identification and the associated QoS class. The classifier as well as the whole Self-Sustaining Scheduler is assigned uniquely to one subscriber.

The flow identification in case of IPv6 could be the Flow Label, a 20 bit field in the IPv6 packet header. According to RFC3697 Flow Labels should be assigned in such a way that different flows do not receive the same Flow Label. Hence the combination of IP source address and Flow Label is a unique identifier for an IPv6 packet flow. Advantage of the Flow Label field is that it is not included in IPsec protection and hence can be modified in between endpoints, for example by the home gateway. In case of IPv4 a combination of IP source address, DSCP and TCP/UDP port number could be used for flow identification.

The classifier must explicitly learn the labels and the associated QoS class. For this purpose a control channel from Terminal Agents to the classifier in the Self-Sustaining Scheduler is used, preferably with a compact packet format. For Ethernet access networks a layer two frame with a suitable Ether-type value could be used. The protocol does not need acknowledgement, as the result can be noticed. In case of a lost control packet it would be retransmitted after timeout.

The classifier maintains the list of entries in a self-sustaining way. If the user asks for more entries than available the oldest exiting entry is replaced by the new one. Similar to Ethernet MAC tables unused entries would age out after a certain time. When a user packet is received the classifier checks all entries and if the flow identification is not found the packet is forwarded with default QoS class, typically Best Effort.

The above description of illustrated embodiments of the invention, including what is defined in the Abstract, is not intended to be exhaustive or to limit the invention to the precise forms disclosed. While specific embodiments of, and examples for, the invention are described herein for illustrative purposes various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

1. A communication system with these characteristics:
a Remote Resource Manager with subscriber status information,
at least one terminal containing a Terminal Agent,
whereby the Terminal Agent is configured to setup a packet-oriented control channel to the Remote Resource Manager and
to derive QoS requirements from the terminal's applications and to send this QoS requests to the Remote Resource Manager via said control channel,
to get back QoS control information to adjust send rates of the data flows and to mark the packets of the data flow accordingly, so that Self-Sustaining Schedulers in the data path especially designed to forward data flows to or from the terminals solely according to the marking of the packets, with given latency and packet drop rate.

2. A communication system according to claim 1, whereby the Self-Sustaining Scheduler is designed to guarantee well-defined latency for each QoS class depending solely on the marking of the packets, without the need for re-configuration due to load variations.

3. A communication system according to claim 1, comprising a Self-Sustaining Scheduler supporting some time priorities and importance priorities whereby packets marked with higher time priority are forwarded faster as packets with lower time priority and packets marked with low importance are more likely to be dropped than packets marked as high importance.

4. A communication system according to claim 1, comprising either a data flow between a subscriber and a network node or a data flow of layer 2 or 3 of the OSI model.

5. A communication system according to claim 1, wherein at least one of the Self-Sustaining Schedulers connected to a network node.

6. A communication system according to claim 1, wherein the Remote Resource Manager is external to the network which is forwarding the data stream.

7. A communication system according to claim 1, wherein at least one Terminal Agent is realized as plug-in or applet.

8. A method, comprising:
generation of QoS control information in a Remote Resource Manager depending on the status stored in the Remote Resource Manager,
sending the QoS control information via a packet-based control channel from the Remote Resource Manager to at least one terminal;
sending a packet stream from the terminal to a destination whereby the rate of the packet stream is adjusted according to the received QoS control information and whereby the packets are marked according to the received QoS control information, and
whereby the packet streams are forwarded by the Self-Sustaining Schedulers in the data path with well defined time behavior independent on the actual load.

9. A method according to claim 8, wherein the packets of the packet stream are marked by the DiffServ coding (DSCP) in the IP packet header.

10. A method according to claim 8, wherein the Remote Resource Manager limits the rates of the individual packet streams so that in the Self-Sustaining Scheduler given packet latencies and drop rates for the QoS classes are not exceeded.

11. A method according to claim 8, wherein the subscriber access line can be realized as twisted pair copper line (DSL), power-line, wireless technologies such as WiMAX, UMTS etc. or as fiber.

12. A method according to claim 8, wherein the rate of remote packet stream sources is limited by delayed emission of acknowledge packets or other inherent methods of the TCP protocol.

13. A method according to claim 8, wherein rate and/or QoS class and/or importance of packets of a video stream are selected so that packets of the basic stream are forwarded by the Self-Sustaining Scheduler with given low drop probability, while packets of the low importance part of the video stream (enhancement stream) may experience a higher drop rate.

14. A method according to claim 8, wherein rate and/or QoS class and/or importance of packets of a on-off packet stream are selected that packets with rate conforming to the minimum guaranteed rate experience a low drop rate while packets exceeding the guaranteed minimum rate may experience a higher drop rate.

15. A method according to claim 8, wherein the packets of the control channel have the SIP format or a compact format.

16. An apparatus comprising:
an Agent in a terminal which notifies requests of the terminal for data transmission and
which requests before or during the setup of the data transmission via a packet-oriented control channel the available bandwidth and QoS class at from a Remote Resource Manager, whereby
either
after reception of QoS class and bandwidth information for transmit and receive directions of the data transmission the Agent adjusts the sending rate and marks the sent packets with the given QoS class and
in addition influences the Terminal Agent of the counterparts of the data transmission via delayed emission of TCP acknowledge packets to adjust their sending rate so that the sum of the rates of the received packet streams does not exceed the bandwidth given by the Remote Resource Manager,
or
after reception of QoS class and bandwidth information of the transmit direction adjusts the send rate and marks the sent packets in the IP packet header accordingly,
whereby in addition the Remote Resource Manager informs the Agent in the counterpart terminal of the data transmission about the packet rate of the stream to be adjusted and the QoS class marking for the packets of the stream.

17. A communication system, comprising:
a Remote Resource Manager with subscriber status information,
at least one terminal containing a Terminal Agent,
whereby the Terminal Agent is configured to setup a packet-oriented control channel to the Remote Resource Manager and
to derive QoS requirements from the terminal's applications and to send this QoS requirements to the Remote Resource Manager via said control channel,
to get back QoS control information to adjust send rates of the data flows and to mark the packets of the data flow accordingly and
to send out control messages to a Self-Sustaining Scheduler at the network side of the subscriber access line whereby these messages configure the flow classifier of the Self-Sustaining Scheduler to associate the packet flow to a QoS class and whereby the Self-Sustaining Scheduler forwards packets of that flow with given delay and packet drop probabilities.

18. A communication system according to claim 17, wherein the packet QoS marking is done via the IPv6 Flow Label optionally in combination with IP source header.

19. A communication system according to claim 17, wherein the packet QoS marking is done via combinations of IP and TCP header fields.

20. A Self-Sustaining Scheduler, comprising: a configurable classifier capable to detect a given amount of flows by packet inspection and assign QoS classes to the flows for local usage within the Self-Sustaining Scheduler.
